(19) United States
(12) Patent Application Publication
(10) Pub. No.: US 2002/0084098 A1
(43) Pub. Date: Jul. 4, 2002

(54) High frequency-resistant insulated winding wires

(75) Inventors: Chih-Min Jang, Taipei (TW); Ru-Shi Liu, Hsinchu Hsien (TW); Chi-Ting Du, Taipei (TW); Wen-Lu Tai, Taoyuan (TW); Yao-Chung Tu, Hsinchu (TW); Wen-Hsiung Liu, Taipei (TW); Wen-Chang Wu, Taipei Hsien (TW); Yung-Chin Lin, Hsinchu (TW); Shang-Yen Chang, Hsinchu (TW)

Correspondence Address: LADAS & PARRY, 26 WEST 61ST STREET, NEW YORK, NY, 10023, US

(73) Assignee: TAI-I ELECTRIC WIRE & CABLE CO., LTD

(21) Appl. No.: 09/849,589

(22) Filed: May 4, 2001

Related U.S. Application Data
(63) Continuation-in-part of application No. 09/430,882, filed on Nov. 1, 1999, now abandoned.

(30) Foreign Application Priority Data
Jul. 22, 1999 (TW) 88112450

(51) Int. Cl. H01B 1/00

(52) U.S. Cl. 174/110 R

(57) ABSTRACT

A high frequency-resistant enamelled wire including a metal conductor as a core having a diameter of 0.1 to 1.5 mm and a coat layer superimposed on the core having a thickness of 0.079 to 0.13 mm. The high frequency-resistant insulated winding wire has excellent adhesion on the core and are mainly used in power supply transformers and winding materials for high frequency in electrical machines.

### FIELD OF THE INVENTION

The present invention relates to a high frequency-resistant insulated winding wire. Particularly, the present invention relates to a high frequency-resistant insulated winding wire obtained by properly controlling the thickness of the coating layer for use in power supply transformers or winding materials for high frequency in electrical machines.

### BACKGROUND OF THE INVENTION

Known enamelled wires for use in a variable frequency motor for pulse-width modulation (PWM) cannot withstand long term frequency shock. U.S. Pat. No. 5,654,095 discloses a process for the manufacture of a pulse-resistant and high frequency-resistant enamelled wires. The improvement of the structure of the high frequency-resistant enamelled wires produced by U.S. Pat. No. 5,654,095 resides in the incorporation of an inorganic metal oxide having fine particulate (0.05 to 1.0 micron) into a coating to accomplish the purpose of pulse-resistance and high frequency-resistance. The inorganic metal oxide is selected from the group consisting of titanium oxide, aluminium oxide, silicon oxide, zirconium oxide, zinc oxide, and iron oxide. The enamelled wires can withstand an instantaneous pulse of 83 kV/msec and a carrier wave up to 20 kHz. However, the process for the manufacture of the enamelled wires is expensive in cost and it is not easy to obtain a homogeneous adhesion between layers is poor after the mixture is coated and cured.

The conventional coating layer materials for enameled wire are polyesterimide (PEI) and polyamideimide (PAI). In order to meet the flexibility requirement according to NEMA MW35C standard, the film thickness should be less than 0.080 mm. Considering its resistance to high frequency surge, inorganic metal oxides such as Cr₂O₄ must be added into the top layer of PAI.

Furthermore, with the minimization of the spacing of transformers, the requirement for high frequency-resistance of power supply increases. For the power supply most widely used in electrical facilities, for instance, switching power supply (SPS); conventional enamelled wires do not meet the requirements.

To meet the requirement for high frequency-resistance, it is necessary to obtain insulated winding wires with low production cost which do not need additional inorganic metal oxides and can be mass-produced without changing the original processing conditions.

### SUMMARY OF THE INVENTION

The object of the present invention is to provide a high frequency-resistant insulated winding wire.

Another object of the present invention is to provide a high frequency-resistant insulated winding wire in which no additional inorganic metal oxides are added.

Yet another object of the present invention is to provide a high frequency-resistant insulated winding wire which is mainly used in a switching power supply transformer or as a winding material for high frequency.

Yet another object of the present invention is to provide a high frequency-resistant insulated winding wire obtained by properly controlling the thickness of insulation coating to obtain both the common physical, electrical and high frequency-resistant properties.

The above features and advantages of the present invention will be better understood with reference to the detailed description and examples. It should also be understood that the high frequency-resistant insulated winding wire illustrating the present invention is exemplary only and not to be regarded as a limitation of the invention.

### BRIEF DESCRIPTION OF THE DRAWING

FIG. 1 shows the relationship between coating thickness and high frequency-resistant lifetime for the subject invention and prior art.

### DETAILED DESCRIPTION OF THE INVENTION

By way of illustration and to provide a more complete appreciation of the present invention with many of the attendant advantages thereof, the following detailed description is given concerning a high frequency-resistant insulated winding wire.

The present invention relates to a high frequency-resistant insulated winding wire, comprising a metal conductor as a core, and a coating layer superimposed on the core.

Metal conductors are known in the art and can be selected for special requirements. The metal conductors may be copper. The cross-section of the metal conductors is preferably in a shape of a circle. The diameter of the metal conductor is in a range of 0.1 to 1.5 mm, preferably in a range of 0.20 to 1.0 mm.

Coating layer materials used by the present invention can be selected fro modified polyurethane which as the thickness in the range from 0.05 to 0.13 mm, preferably in the range from 0.079 to 0.13 mm, more preferably in the range from 0.079 to 0.0102 mm. It is not necessary to add inorganic metal oxides into the coating layer of the present invention.

The solvent used for coating layer materials can be a single solvent or a mixture to dissolve the synthetic resins and to facilitate coating operations. The amount of the solvent is 20 to 80% m, preferably 54 to 60% by weight of the amount of coating layer materials.

The present invention relates to a high frequency-resistant insulated winding wire which is produced from a high frequency-resistant thermosetting polyurethane (PU) coating. When the thickness of coating is up to 0.085 mm, the high frequency-resistant properties of the insulated winding wire are outstanding.

The modified polyurethane used in the subject invention is obtained from mixing block diisocyanate component and esterified polyol component in an appropriate ratio.

The block diisocyanate component is produced from polymerized components comprising a diisocyanate, a methylol alkyl, and a tertiary amine. The molar ratio between the diisocyanate and methylol alkyl is in a range from 0.7 to 1.3:0.1:0.6.

The esterified polyol component is produced from components comprising a terephthalate (or terephthalic acid), an anhydride, p,p′-diaminodiphenylmethane, and at least one polyols in a molar ratio of 0.7 to 1.3:0.7 to 1.3:0.3 to 0.7:2 to 4. A catalyst such as tetrabutyl titanate can be added in an amount of 0.1 o 0.2% by weight.

The diisocyanate used are exemplified as toluene diisocyanate, methylene diisocyanate, 4,4′-diphenylmethan diisocyanate, hexylene diisocyanate, and xylyene diisocyanate. The methylol alkyl is exemplified as trimethylol propane. The tertiary amine is exemplified as triethylamine.

The polyols used are exemplified as ethylene glycol, diethylene glycol, and glycerol. The molar ratio of ethylene glycol, diethylene glycol, and glycerol is about 1.0 to 1.6:1.0 to 1.6:0.2 to 0.5. The anhydride is exemplified as trimellitic anhydride. The terephthalate is exemplified as dimethyl terephthalate.

The block diisocyanate component is mixed with the polyol esterified component in a ratio of 1:1 to 1:2.5 depending on the molecular weight. The modified polyurethane thus obtained has a solid content about 40 to 46% (drying at 170° C. for 2 hours), preferably 43 to 45%, and has a viscosity of 18 to 25 poise (30° C.), preferably 23 to 25 poise (30° C.). The solvents used may be a single solvent or a mixture of solvents to dissolve the materials for facilitating coating. The amount of solvents is 54 to 60% by weight of the coating.

The high frequency-resistant insulated winding wire of the subject invention is produced from the high frequency-resistant coating. The high frequency-resistant insulated winding wire comprises a metal conductor as a core and a coating layer superimposed on the core. Metal conductors are known in the art and can be selected for special requirements. The metal conductors may be copper. The cross-section of the metal conductors is preferably in a shape of a circle. The diameter of the metal conductor is in a range of 0.1 to 1.5 mm, preferably in a range of 0.20 to 1.0 mm. The high frequency-resistant insulated winding wire possesses outstanding high frequency resistant properties when the thickness of the coating layer is within a range of 0.85 to 0.12 mm.

Since the coating of the subject invention is thermosetting, the coating layer thus obtained is superior to the thermoplastic resins in respect of toughness, adhesion, crosslinking density, abrasion resistance, and softening resistance. When the thickness of the coating layer is up to 90 μm, the high frequency-resistant lifetime is comparable with that of JP 56-93214. When the thickness of the coating layer is up to 97 μm, the high frequency-resistant lifetime is three times or more than that of JP 56-93214. Since the coating layer of the subject invention is not applied to the enamelled wire in a multiple coating manner as that of JP 56-93214, the subject invention is without the adhesion problem. Instead, the use of the subject invention does not involve complicated process and change processing conditions, and is low cost.

The present invention also relates to a method for treating an electronic part to withstand high frequencies comprising:

(a) providing the insulated winding wire as previously mention; and

(b) applying the insulated winding wire as a frequency-resistant winding material to the electronic part so that the electronic part withstands a carrier frequency of up to 10 kHz and a voltage up to 440 V for a lifetime of from 76 to 454 hours.

### Preparation of Insulated Winding Wire

The thickness of the coating layer of the insulated winding wire is properly controlled in a range of 0.05 to 0.130 mm, preferably in the range from 0.085 to 0.102 mm, in my manner such as multi passes coating with a coating speed such as 3 to 20 m/min or by extrusion.

### Test of the Insulated Winding Wires

The high frequency-resistant insulated winding wire of the subject invention is tested and evaluated based on NEMA MW-35C standard for general mechanical and electrical properties.

Twisted wire pairs are used to test and evaluate the high frequency-resistant lifetime of the high frequency-resistant insulated winding wires of the subject invention by high voltage resistant and high frequency-resistant test facilities.

1. Test Facilities

\mathring{1} a booster transformer: 3 φ220/440 V, 10 kVA

\mathring{2} a frequency converter: 3 φ380/400 V, 60 Hz

\mathring{3} five time counters: 110 V, 0˜999 hr

\mathring{4} a 3 φ induction motor: 380/440 V, 3φ3 HP

\mathring{5} five control transformers: 1 φ, 480/110 V

\mathring{6} ten relays; LY-2J, 110 V

\mathring{7} five no fuse breakers: 1A 600 V

\mathring{8} 400 feet of insulated conductor 600 V, 2 mm²

2. Test Conditions

\mathring{1} The frequency converter is controlled provides a pulse-modulated AC waveform.

\mathring{2} The carrier wave voltage at the frequency converter output is 622 V (0 to peak voltage).

\mathring{3} The output of the frequency converter has an average voltage of 440 V, a main frequency of 60 Hz, a modulation frequency of 1.5 kHz, and the waveform of an AC square wave.

\mathring{4} The carrier wave voltage output of the frequency converter is modulated by a voltage variation of 10 kV to 10 kV per microsecond.

3. Test Method

\mathring{1} The induction motor is connected in series to a frequency converter by an electrical wire 100 meters long which is the power supply for the test.

\mathring{2} The boost transformer (3 φ, 220/440 V, 10 kVA) is used to increase the voltage from 220 V to 440 V to supply power to the frequency converter to modulate the main frequency with an AC square wave similar to the waveform of the main frequency.

\mathring{3} The output of the frequency converter has an average voltage of 440 V, a main frequency of 60 Hz, a modulation frequency of 15 kHz, and a sinusoidal square an AC square waveform. The voltage is carried by a 100 meter long insulated conductor wire to a load, such as the induction motor. A twisted wire pair is then connected in parallel between connecting terminals in an isothermal furnace maintained at 195° C. The insulation conductor wire is connected in parallel therein.

\mathring{4} Before performing the test of twisted wire pairs, a piece of the control enamelled wire and a piece of the high frequency-resistant insulated winding wire, each about 1.00 m long, are selected as samples. The samples are folded in half at 30 cm, subjected to a load of 1364 g, and twisted eight (8) revolutions. The samples are cut at fold. The coating layer material was stripped off at each end of the twisted wire pairs so that a 3 cm length of the metal conductor is exposed. Then, the twisted wire pairs are tightly connected to the terminals in the furnace and the door of the furnace is closed. The modulated power is then applied until the coating layer material breaks down, and the high frequency-resistant lifetime is recorded.

### EXAMPLE 1

Preparation of Polyurethane

\mathring{1} Block diisocyanate component (produced by polymerization)

Components and their amounts are as follows:

| | | |
|---|---|---|
| dimethyl terephthalate | 194 g | (1 mole) |
| trimellitic anhydride | 192 g | (1 mole) |
| p,p′-diaminodiphenylmethane | 99 g | (0.5 mole) |
| diethylene glycol | 137.8 g | (1.3 mole) |
| ethylene glycol | 80.6 g | (1.3 mole) |
| glycerin | 34.07 g | (0.37 mole) |
| tetrabutyl titanate | 0.7 g | |

The above components are mixed in a reactor. The reactor is purged with nitrogen. The contents of the reactor is gradually heated to 230±5° C. The temperature of the contents are maintained for 5 to 8 hours for carrying out dehydration (about 72 to 75 g of water is dehydrated) and methanol removal until no more water is distilled. A acid value of equal or less than 5 mg KOH/g means that the reaction is finished. Thereafter, the temperature is reduced to 180° C. Cresol (240 g) and xylene (240 g) are added to the reactor to dissolve and dilute the contents.

The solid content of the final product is 55±0.5% (dried at 170° C. for 2 hours).

Viscosity of the product is 200 to 400 poise (30° C.).

\mathring{2} Esterified polyol component

Methylene diisocyanate (250 g, 1 mole) and xylene (305 g 2.5 mole) are mixed in a reactor. The contents of the reactor reaction begins to effect considerable exothermic reaction at 60° C. and is under reaction at 125° C. for about 2 hours. Trimethylolpropane (44.67 g, 0.3 mole) and triethylamine (0.25 g) are added in the reactor at 125° C. and continue reacting for 6 to 8 hours. Thereafter, cresol (47 g) and xylene (47 g) are added in the reactor and the contents are cooled. Nitrogen should be purged into the reactor during the reaction.

The solid content of the final product is 55±0.5% (dried at 170° C. for 2 hours).

Viscosity of the product is 60 to 80 poise (30° C.).

\mathring{3} Polyurethane

| | | |
|---|---|---|
| esterified polyol component(solid content is 55 ± 0.5%) | 100 | g |
| block diisocyanate (solid content is 55 ± 0.5%) | 200 | g |
| triethylamine | 0.33 | g |
| cresol | 22 | g |
| xylene | 22 | g |

The above block diisocyanate component \hat{1} and esterified polyol component \hat{2} are mixed and a homogeneous product \hat{3} is obtained. The solid content of the product is about 43 to 45% (dried at 170° C. for 2 hours). Viscosity of the product is about 23 to 25 poise (30° C.).

### Example 2

Control

Polyesterimide containing 5% Cr₂O₃ and polyamideimide are coated on a copper wire having a diameter of 1.024 mm by a coating tower (base coating in 8 passes and coat coating in 4 passes), first base coating and then top coating. Cr₂O₃ is incorporated into polyamideimide as top coating and the mixture is blended homogeneously.

Coating Condition: line speed: 10 m/min

the length of furnace: 3.5 m

the inlet temperature of the furnace: 360° C.

the outlet temperature of the furnace: 480° C.

### Examples 3 to 6

The Insulated Winding Wire of the Present Invention

The coating material used is the product produced in Example 1 of the present invention has no inorganic metal oxide. The coating thickness is in the range from 0.079 to 0.102 mm.

General electrical properties of the insulated winding wires made from the control and examples of the invention are tested according to NEMA MW-35C standard. The high frequency-resistant lifetime of the twisted wire pairs are tested by high frequency facility. The results are as shown in Table below.

TABLE 1

| | | | | | | | | | high |
|---|---|---|---|---|---|---|---|---|---|
| | | | | | | | | | frequency- |
| | | | | | | | | anti- | resistant |
| | | | coated | outer | | | | softing | lifetime |
| | | diameter of | thickness | diameter | | B.D.V. | elongation | point | 622 V 15 |
| Item | Filler | conductor | (mm) | (mm) | adhesion | (kV) | (%) | (° C.) | kHz (hr) |
| NEMA | — | +1.029 | 0.066 ↑ | 1.110 ↓ | no crack | 5.7 ↑ | 32% ↑ | 320 ↑ | — |
| MW- | | −1.014 | | | | | | | |
| 35C | | | | | | | | | |
| control | Cr₂O₃ | 1.022 | 0.081 | 1.103 | good | 12.8 | 37.5 | 393 | 58.3 |
| Exp. 3 | — | 0.990 | 0.079 | 1.148 | good | 14.5 | 34.5 | 250 | 20.4 |
| Exp. 4 | — | 0.990 | 0.085 | 1.160 | good | 16.8 | 35.0 | 246 | 92.6 |
| Exp. 5 | — | 0.989 | 0.0965 | 1.182 | good | 18.0 | 34.0 | 244 | 230.5 |
| Exp. 6 | — | 0.988 | 0.102 | 1.191 | good | 19.4 ↑ | 33.5 | 256 | 453.7 |

B.D.V represents breakdown voltage
NEMA MW-35C: enamelled wire standard of USA.

As shown in the results in Table 1, the high frequency-resistant lifetime in Example 2.2 is 70.4 hours, which is longer than that of the control (58.3 hours) by about 18 hours. By properly controlling the coating thickness in a range of 0.079 to 0.102 mm, the lifetime can be increased to 453.7 hours.

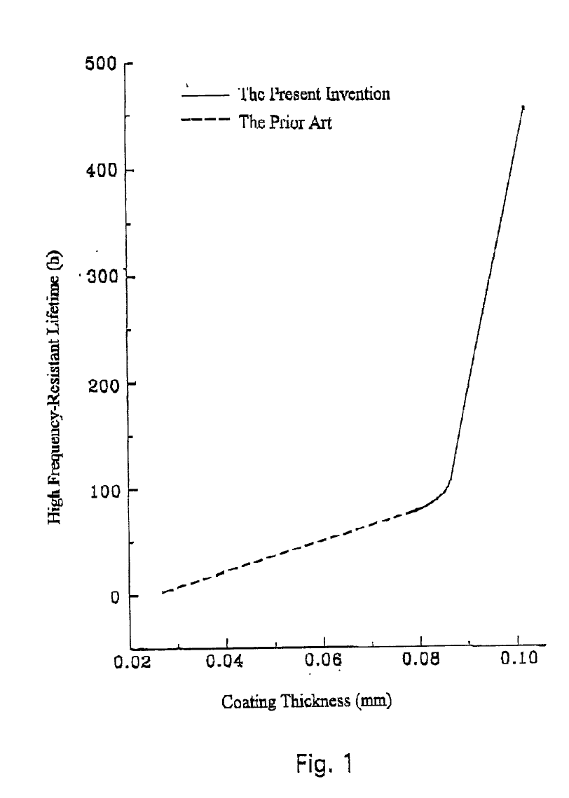

FIG. 1 is based on the result of Table 1. In FIG. 1, it is clear that the high frequency resistant lifetime can be increased by the subject invention by increasing the coating thickness. When the coating thickness is in a range of 0.079 to 0.102 mm, the high frequency-resistant lifetime obtained is obviously longer than that of conventional enamelled wires incorporating Cr₂O₃ thereto.

The present invention may, of course, be carried out in other specific ways than those herein set forth without departing from the spirit and essential characteristics of the present invention. The present embodiments are, therefore, to be considered in all respects as an illustration and not restrictive. Therefore, any changes coming within the meaning and equivalent range of the appended claims are to be embraced therein.

We claim:

1. A high frequency-resistant insulated winding wire comprising a metal conductor as a core having a diameter of 0.1 to 1.5 mm and a coating layer superimposed on the core, said coating layer being substantially free of inorganic metal oxides and having a thickness of 0.05 to 0.13 mm.

2. An insulated winding wire according to claim 1, wherein said metal conductor has a circular cross-section.

3. An insulated winding wire according to claim 1, wherein said metal conductor is copper.

4. An insulated winding wire according to claim 1, wherein the diameter of said metal conductor is 0.20 to 1.0 mm.

5. An insulated winding wire according to claim 1, wherein the thickness of said coating layer is 0.085 to 0.120 mm.

6. An insulated winding wire according to claim 1, wherein the thickness of said coating layer is 0.079 to 0.102 mm.

7. An insulated winding wire according to claim 1, wherein said coating is formed by extrusion or multi-pass coating.

8. An insulated winding wire according to claim 1, wherein said coating is thermosetting polyurethane comprising a block diisocyanate component and an esterified polyol component, which is produced by mixing said block diisocyanate and said esterified polyol in a ratio of 1:1 to 1:2.5, wherein
said block diisocyanate component comprises a diisocyanate, a methylol alkyl, and a tertiary amine, wherein the molar ratio between the diisocyanate and methylol alkyl is 0.7 to 1.3:0.1:0.6, and
said esterified polyol component comprises a terephthalate, an anhydride, p,p′-diaminodiphenylmethane, and an least one polyols in a molar ratio of 0.7 to 1.3:0.7 to 1.3:0.3 to 0.7:2 to 4.

9. An insulated winding wire according to claim 8, wherein said diisocyanate is selected from toluene diisocyanate, methylene diisocyanate, 4,4′-diphenylmethane diisocyanate, hexylene diisocynate, and xylyene diisocynate.

10. An insulated winding wire according to claim 8, wherein said methylol alkyl is trimethylol propane.

11. An insulated winding wire coating according to claim 8, wherein said tertiary amine is triethylamine.

12. An insulated winding wire according to claim 8, wherein said terephthalate is dimethyl terephthalate.

13. An insulated winding wire coating according to claim 8, wherein said anhydride is trimellitic anhydride.

14. An insulated winding wire according to claim 1, wherein said esterified polyol component comprises ethylene glycol, diethylene glycol, and glycerin in a molar ratio of 1.0 to 1.6:1.0 to 1.6:0.2 to 0.5.

15. An insulated winding wire according to claim 1, further comprising a single solvent or a solvent mixture, wherein the amount of said solvent is 54 to 60% by weight of said coating.

16. An insulated winding wire according to claim 1 for use in winding materials for switching power supply transformers.

17. An insulated winding wire according to claim 1, which is used as a frequency-resistant winding material for applying to electronic parts to withstand a carrier frequency up to 10 kHz, a voltage up to 440 V (from zero to peak value), and frequency-resistant lifetime 76 up to 454 hours when the thickness of said coating layer increases from 0.079 to 0.102 mm.

18. A method for treating an electronic part to withstand high frequencies comprising:
(a) providing the insulated winding wire of claim 1; and
(b) applying the insulated winding wire as a frequency-resistant winding material to tho electronic part so that the electronic part withstands a carrier frequency of up to 10 kHz and a voltage up to 440 V for a lifetime of from 76 to 454 hours.
